(19) United States
(12) Patent Application Publication
(10) Pub. No.: US 2024/0377906 A1
(43) Pub. Date: Nov. 14, 2024

(54) Sensor Module and Control Method for Sensor Module

(71) Applicant: Japan Display Inc., Tokyo (JP)

(72) Inventor: Takayuki NAKANISHI, Tokyo (JP)

(21) Appl. No.: 18/426,687

(22) Filed: Jan. 30, 2024

(30) Foreign Application Priority Data
Feb. 3, 2023 (JP) 2023-015723

(51) Int. Cl. G06F 3/041; G06F 3/044

(52) U.S. Cl. CPC G06F 3/0418; G06F 3/0446; G06F 2201/86; G06F 2203/04101

(57) ABSTRACT

A sensor module includes a cover member, a contactless sensor substrate arranged with a sensor region having a plurality of sensor electrodes and overlapping the cover member, and a controller receiving a detection signal output from the sensor substrate and generating a three-dimensional coordinate data based on the detection signals.

### CROSS-REFERENCE TO RELATED APPLICATIONS

This application claims the benefit of priority to Japanese Patent Application No. 2023-015723, filed on Feb. 3, 2023, the entire contents of which are incorporated herein by reference.

### FIELD

An embodiment of the present invention relates to a sensor module, a control method for a sensor module, a program, a display device including the sensor module, and a sensor system.

### BACKGROUND

A touch sensor is widely used as an interface for inputting information to an information terminal. A currently mainstream touch sensor specifies a position at which an input jig (hereinafter, also referred to as an input unit) such as a human finger, palm, or a touch pen directly contacts the touch sensor. For example, Patent Literature 1 (e.g., Japanese laid-open patent publication No. 2018-97820) discloses a touch panel system that detects a touch position with appropriate accuracy on a touch panel that accepts input by a finger and a pen.

### SUMMARY

A sensor module according to an embodiment of the present invention includes a cover member, a contactless sensor substrate arranged with a sensor region having a plurality of sensor electrodes and overlapping the cover member, and a controller receiving a detection signal output from the sensor substrate and generating three-dimensional coordinate data based on the detection signal, wherein the controller includes a coordinate calculation unit generating the three-dimensional coordinate data indicating a position of an input means in the sensor region when the input means is in proximity to the sensor region, a height condition determination unit determining whether or not a Z-coordinate representing a height from the sensor region in the three-dimensional coordinate data is less than a first threshold value and whether or not the Z-coordinate is a second threshold value is less than the first threshold value, and an output unit outputting a control signal corresponding to the position of the sensor region when the height condition determination unit determines that the Z-coordinate is equal to or less than the first threshold value and the second threshold value.

A method for controlling a sensor module according to an embodiment of the present invention, the sensor module comprising a cover member and a sensor region having a plurality of sensor electrodes and detecting a detection signal output from a contactless sensor substrate overlapping the cover member, the method comprising steps of the method comprising steps of generating a three-dimensional coordinate data indicating a position of an input means in the sensor region based on a detection signal output from the sensor substrate when the input means is in proximity to the sensor region, and outputting a control signal corresponding to a position in the sensor region when the height condition determination unit determines that the Z-coordinate is equal to or less than the first threshold value and the second threshold value.

### BRIEF DESCRIPTION OF DRAWINGS

FIG. 1 is a cross-sectional view of a touch sensor system according to an embodiment of the present invention.

FIG. 2 is a perspective view of a touch sensor system according to an embodiment of the present invention.

FIG. 3 is a block diagram of hardware of a touch sensor system according to an embodiment of the present invention.

FIG. 4 is a block diagram of software illustrating a control method for a sensor module according to an embodiment of the present invention.

FIG. 5 is a diagram for explaining a first threshold and a second threshold in a Z coordinate in the sensor module.

FIG. 6 is a flowchart illustrating a control method for a sensor module according to an embodiment of the present invention.

FIG. 7 is a perspective view of a sensor module according to an embodiment of the present invention.

FIG. 8 is a cross-sectional view of a touch sensor system according to an embodiment of the present invention.

FIG. 9 is a block diagram of a hardware of a touch sensor system according to an embodiment of the present invention.

FIG. 10 is a cross-sectional view of a touch sensor system according to an embodiment of the present invention.

FIG. 11 is a cross-sectional view of a touch sensor system according to an embodiment of the present invention.

### DESCRIPTION OF EMBODIMENTS

Hereinafter, each embodiment of the present invention will be described with reference to the drawings and the like. However, the present invention can be implemented in various aspects without departing from the gist thereof, and is not to be construed as being limited to the description of the embodiments exemplified below.

Although the widths, thicknesses, shapes, and the like of the respective portions may be schematically represented in comparison with actual embodiments for clarity of explanation in the drawings, the drawings are merely examples, and do not limit the interpretation of the present invention. Elements having the same functions as those described with respect to the above-described drawings are denoted by the same reference signs, and redundant descriptions thereof may be omitted in the present specification and the drawings. The same symbol is used to collectively represent the same or similar structures, and hyphens and natural numbers are added after the symbols when they are individually represented.

The term “above” shall include both arranging another structure directly above a certain structure and arranging another structure above a certain structure via yet another structure, unless otherwise specified when expressing the manner of arranging another structure on a certain structure in this specification and claims.

### First Embodiment

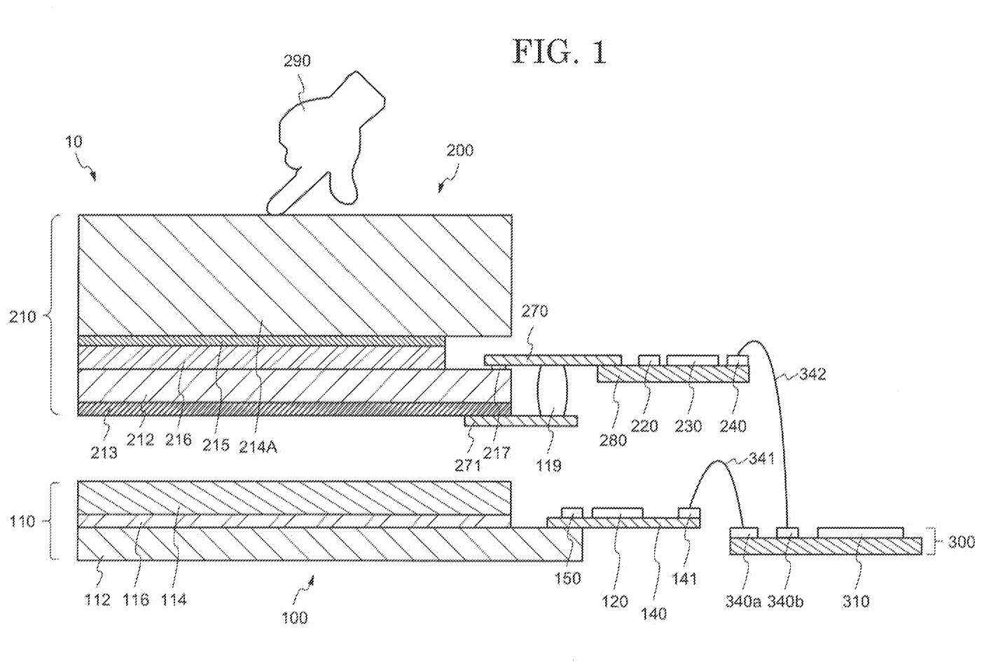

A touch sensor system according to an embodiment of the present invention will be described with reference to FIG. 1 to FIG. 7.

### 1. Configuration of Touch Sensor System

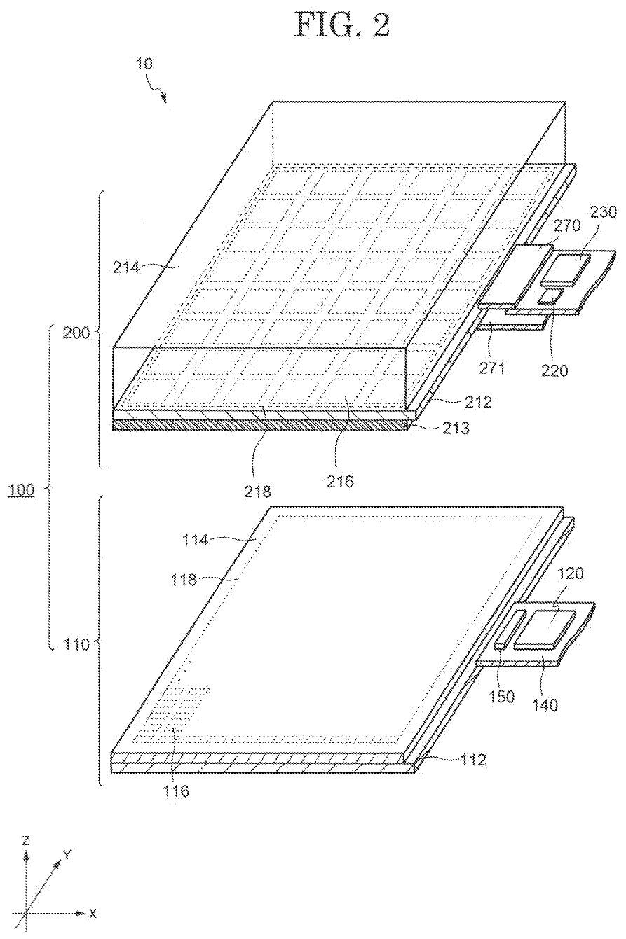

FIG. 1 is a schematic cross-sectional view of a touch sensor system 10 according to an embodiment of the present invention. FIG. 2 is an exploded view of a sensor module 200 and a display module 100 according to an embodiment of the present invention. The touch sensor system 10 includes the sensor module 200, the display module 100, and a computing device 300 as shown in FIG. 1.

### 2. Display Module

The display module 100 includes a display panel 110 and a display controller 120. The display panel 110 includes an array substrate 112, a plurality of pixels 116 formed above the array substrate 112, and a counter substrate 114 covering the plurality of pixels 116, as a basic configuration. A region where the plurality of pixels 116 is arranged is also referred to as a display region 118. The plurality of pixels 116 is arranged in a matrix having a plurality of rows and columns as shown in in FIG. 2. The pixel 116 has a display element and functions as the smallest unit for providing color information. A liquid crystal element, an inorganic electroluminescent element (LED), or an organic electroluminescent element (OLED) is used as the display element. In the case where a liquid crystal element is used, a light source (backlight) (not shown) is arranged on a back surface of the display panel 110. The display controller 120 is connected to the computing device 300 via a connector 140, such as a flexible printed circuit (FPC) substrate. The display controller 120 operates according to power source and a video signal supplied from the computing device 300 via the connector 140 and controls the plurality of pixels 116 via an IC driver 150 to provide light of a particular color with a gradation based on the video signal. The IC driver 150 includes one or both of a gate line drive circuit and a source line drive circuit for driving the plurality of pixels 116. In addition, a configuration in which these drive circuits are arranged on the array substrate may also be employed. Controlling the operations of the plurality of pixels 116 based on the video signal makes it possible to display an image on the display region 118. The plurality of pixels 116 is configured such that an image is visible through the sensor module 200.

The size of the display panel 110 is not limited, and may be, for example, a size used for a 4-inch (about 10 cm) size mobile communication terminal or the like, a size suitable for a monitor, a television, a signage, or the like connected to a computer (for example, a size of 14.1 inches (36 cm) to 32 inches (81 cm)), or may be a larger size. More specifically, it may be sized to fit a display device built into a cash register or automated teller machine in addition to an in-vehicle display device.

### 3. Sensor Module

The sensor module 200 is arranged above the display module 100. The sensor module 200 may be arranged to have a space (air gap) with the display module 100. Alternatively, the sensor module 200 may be fixed to the display module 100 by an adhesive layer (not shown).

The sensor module 200 is a contactless sensor module (hover sensor). The sensor module 200 has a function of detecting an input means 290 not only when the input means 290 such as a finger, a palm, or a touch pen having a resin arranged on its tip is in direct contact with the sensor module 200, but also when the input means 290 approaches the sensor module 200 without being in contact with the sensor module, and specifying the position of the input means 290 on the sensor module 200 (hereinafter, also referred to as an input position). A distance at which the sensor module 200 detects the input means 290 can be set as appropriate, within 5 mm, within 20 mm, within 50 mm, or within 100 mm from a surface of a sensor electrode to be described later. The distance at which the sensor module 200 detects the input means 290 may be set such that a touch can be detected when the input means 290 touches a cover member 214 or may be set such that a touch can be detected even when the input means 290 does not touch the cover member 214. The distance for detecting the input means 290 is set so that a touch can be detected when the input means 290 touches the cover member 214 in the present embodiment.

The sensor module 200 includes a sensor panel 210, a detector 220, and a sensor controller 230. The sensor panel 210 includes a sensor substrate 212, a plurality of sensor electrodes 216 formed above the sensor substrate 212, and the cover member 214 covering the plurality of sensor electrodes 216. The plurality of sensor electrodes 216 is arranged in a matrix having a plurality of rows and columns. A region where the plurality of sensor electrodes 216 is arranged is referred to as a sensor region 218. The sensor substrate 212 on which the sensor region 218 is formed is also referred to as a sensor array. The sensor substrate 212 is a contactless type. The sensor electrode 216 is arranged so that the sensor region 218 overlaps the display region 118. The number (that is, the number of rows and columns) and the size (area) of the sensor electrode 216 may be appropriately set according to the size of the display region 118, the accuracy of detection required for the sensor module 200, and the like. For example, the number of rows and columns may be respectively 5 or more and 10 or less, and 5 or more and 15 or less. Each sensor electrode 216 has a larger area than the pixel 116 and is arranged so as to overlap the plurality of pixels 116 as can be seen from FIG. 2.

A sensor wiring (not shown) is connected to the plurality of sensor electrodes 216, and a drive signal is supplied via the sensor wiring. The drive signal may be a pulsed voltage. A pseudo capacitor is formed between the sensor electrode 216 and the input means when a conductor (for example, a human finger) that is the input means 290 approaches the sensor electrode 216. As a result, the capacitance of the sensor electrode 216 changes. The change in capacitance may be output as a detection signal. In addition, the magnitude of the capacitance of the sensor electrode may be output as the detection signal.

The sensor wiring (not shown) electrically connected to the sensor electrode 216 extends from the sensor electrode 216 to one side of the sensor substrate 212 to form a terminal 217 at an end portion. A connector 270 such as a flexible printed circuit (FPC) substrate is electrically connected to the terminal 217. The connector 270 is connected to a connector 280, such as a printed circuit board (PCB). The detector 220, the sensor controller 230, and an I/F 240 (Interface) are arranged in the connector 280. Signals detected from the plurality of sensor electrodes 216 are transmitted to the computing device 300 via the detector 220, the sensor controller 230, and the I/F 240. In addition, the process whereby the detection signal detected by the plurality of sensor electrodes 216 will be described later.

Each of the sensor substrate 212 and the cover member 214 is an insulating material, and is made of a polymer material such as, for example, glass, quartz, polyimide, polyamide, or polycarbonate. In addition, the sensor substrate 212 and/or the cover member 214 may have flexibility that can be deformed as desired, or may have flexibility that is low enough not to be plastically deformed. A thickness of a cover member 214 may be a thickness corresponding to the distance at which the sensor region 218 detects the input means, and may be, for example, a thickness of 1 mm or more and 100 mm or less, in the present embodiment. Alternatively, a thickness of the cover member 214 may be 5 mm or less.

For example, the sensor electrode 216 includes a light transmittance oxide such as indium-tin mixed oxide (ITO) or indium-zinc mixed oxide (IZO). Alternatively, the sensor electrode 216 may include a metal (a zero-valent metal) such as titanium, molybdenum, tungsten, aluminum, copper, or an alloy including one or more of these metals. In the case where a metal or alloy is used, the sensor electrode 216 may be formed in a mesh-like manner having a plurality of openings in order to ensure light transmittance. In addition, the sensor substrate 212 and the cover member 214 are bonded together by an adhesive material 215, for example, an OCA (Optical Clear Adhesive), arranged above the sensor electrode 216.

It is preferable to arrange a noise shield layer 213 for shielding electric effects on a second surface of the sensor substrate 212, which is opposite to a first surface on which the sensor electrode 216 is arranged. The noise shield layer 213 is arranged over the entire surface of the second surface. A metal oxide having light transmittance such as ITO or IZO or a metal is used as the noise shield layer 213. A connector 271 such as a flexible printed circuit is connected to the noise shield layer 213. A pulsed AC voltage in the same phase as the voltage applied to the sensor electrode 216 is applied to the noise shield layer 213. As a result, the noise shield layer 213 is constantly at the same voltage as the sensor electrode 216. In addition, the connector 271 arranged on the second surface of the sensor substrate and the connector 270 arranged on the first surface of the sensor substrate are connected by a solder 119.

### 4. Computing Device

The computing device 300 is an electronic device having a computing function, such as a body part of a desktop-type computer. An I/F 340a of the computing device 300 is connected to an I/F 141 of the display module 100 by a connection means 341. An I/F 340b of the computing device 300 is connected to the I/F 240 of the sensor module 200 by a connection means 342. In addition, a portable communication terminal such as a notebook personal computer, a tablet, or a smart phone in which the computing device 300 and the display module 100 are integrated may be referred to as the computing device 300. Alternatively, a terminal device in which the computing device 300, the display module 100, and the sensor module 200 are integrated may be referred to as the computing device 300.

For example, in the case where a thick object is arranged between the sensor substrate on which a plurality of sensor electrodes is arranged and an input means, or in the case where there is a space between the sensor substrate and the input unit in a conventional touch sensor, the sensor substrate and the input unit are too far apart from each other, so that the sensor cannot be sufficiently sensitive to detect the touch.

Using a hover sensor as the sensor module makes it possible to detect the input means even if a thick object is arranged on the sensor substrate. A method of detecting that the input means touches the object may be a method that determines whether the input means touches the object based on the Z coordinate of three-dimensional coordinate data of the input means obtained by the hover sensor. However, in the case where a capacitive sensor module is used, the Z coordinate in the sensor region depends on the capacitance between the sensor electrode and the input means, that is, the strength of the detection signal. Therefore, a difference occurs in the strength of the detection signal depending on the size of the input means for detecting touch, and a difference occurs in the Z coordinate obtained from the detection signal. Therefore, if one tries to detect touch using only a certain threshold value, a person with large fingers may be judged to be touching even when his/her fingers are not in contact with a thick object with a gap from the surface of the object. Alternatively, if a touch is to be detected only with a certain threshold, it may be determined that a finger is not touched even if the finger is in contact with the surface of the thick object in the case where the finger is small. As described above, there is a problem that the touch cannot be correctly detected depending on the size of the input means.

Therefore, an object of an embodiment of the present invention is to improve the touch sensitivity even in the case where the sensor substrate and the contact surface of the input means are separated from each other.

Specifically, it may be configured that the difference between the case where the input means 290 is not in contact with the cover member 214 but is close to a certain degree and the case where it is actually in contact with the cover member 214 can be accurately identified. In the case where the input means 290 is close to the cover member and is not in contact, the position of the input means 290 or the tip of the input means 290 is not stable because it is positioned in the air, resulting in a variation in the three-dimensional coordinate data of the input means 290 obtained from the detection signal. In addition, in the case where the input means 290 is in contact with the cover member 214, the position of the input means 290 is more stable than in the above-described close-up condition because it is supported by the cover member 214. In other words, the variation in the three-dimensional coordinate data of the input means 290 obtained from the detection signal is reduced. As described above, using the variation in the three-dimensional coordinate data makes it possible to accurately identify whether the input means contacts the cover member even in the case where the sensor substrate and the contact surface of the input unit are separated from each other.

### 5. Hardware of Touch Sensor System

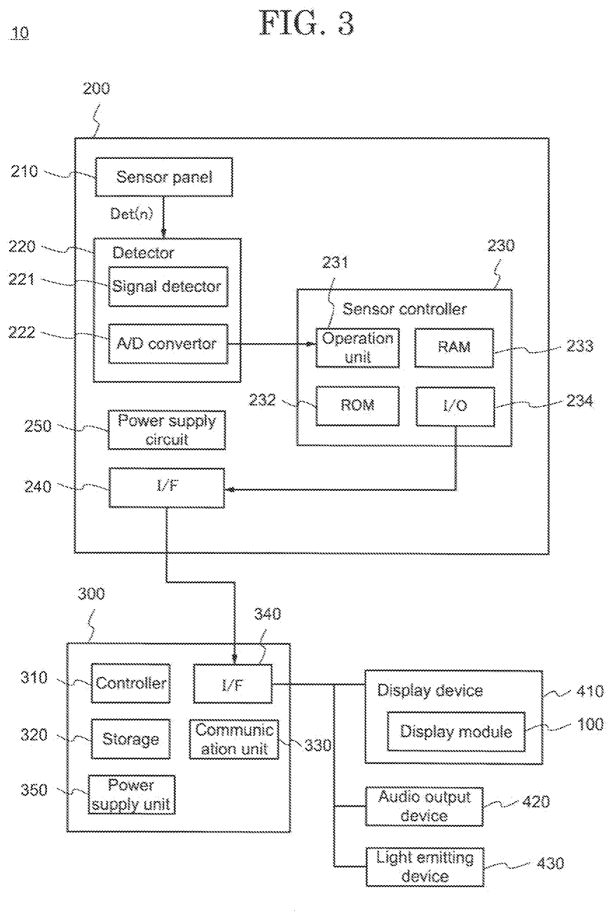

FIG. 3 is a block diagram illustrating hardware of the touch sensor system 10 according to an embodiment of the present invention. The sensor module 200 includes the detector 220, the sensor controller 230, the I/F 240, and a power supply circuit 250 in addition to the sensor panel 210, as shown in FIG. 3.

The detector 220 is also referred to as an analog front end (AFE) and includes a signal detector 221 and an analog/digital converter (A/D converter 222). The signal detector 221 detects a change in capacitance of the sensor electrode 216 as a voltage variation in an analogue signal. The A/D converter 222 includes an analog/digital circuit, and converts an analog signal indicating a voltage variation into a digital signal to be the detection signal.

For example, the sensor controller 230 is also referred to as an MCU (Micro Controller Unit) and has at least an operation unit 231, a ROM 232 (Read Only Memory), a RAM 233 (Random Access Memory), and an I/O interface 234 (Input Output Interface). The operation unit 231 has an operation circuit, and is specifically a CPU (Central Processing Unit) and executes programs stored in the ROM 232. In this case, the program is a program for realizing a control method for a sensor module described in detail later. In addition, the ROM 232 stores a distance for detecting the input means 290. For example, the RAM 233 stores the signal acquired from the detector 220 and the operation result of the detection signal calculated by the operation unit 231. An I/O 234 transmits the signal output from the operation unit 231 to the computing device 300 via the I/F 240.

The I/F 240 is used to connect to the computing device 300 and is configured based on standards such as Universal Serial Bus (USB) and Serial Peripheral Interface (SPI).

The power supply circuit 250 converts the power source supplied from an external power source (not shown) via the computing device 300 into a pulsed AC voltage (AC square wave), and supplies the AC voltage to each sensor electrode 216 via the terminal 217 and the sensor wiring.

The computing device 300 includes a controller 310, a storage 320, a communication unit 330, the I/F 340, and a power supply unit 350. In addition, the computing device 300 may be connected to at least one of a display device 410, an audio output device 420, and a light emitting device 430, which are external output devices, via the I/F 340. The computing device 300 is connected to the display device 410, the audio output device 420, and the light emitting device 430 by wire or wirelessly. In addition, the computing device 300 may be connected to other computing devices by the communication unit 330.

The controller 310 is an MPU (Micro Processor Unit) or an MCU (Micro Controller Unit) on which a CPU is mounted. The controller 310 executes programs stored in the storage 320 by the CPU to realize various functions. For example, the program stored in the storage 320 is an application program for controlling the display device 410, the audio output device 420, or the light emitting device 430. The controller 310 executes the application program based on a control signal received from the sensor controller 230, and outputs various control signals to the display device 410, the audio output device 420, or the light emitting device 430. For example, the display of the display device 410 may be controlled by the application program executed by the controller 310, a sound may be output from the audio output device, or the light emitting device may be turned on.

The storage 320 is configured by a volatile main storage device and a non-volatile auxiliary storage device. The main storage device is a RAM, a DRAM, or the like, and examples of the auxiliary storage device include a ROM, a flash memory, and a hard disk drive. The application program is stored in the auxiliary storage device constituting the storage 320.

The communication unit 330 is a wireless communication module that connects to a network and transmits and receives data to and from other devices, such as other computing devices or servers connected to the network under the control of the controller 310.

The power supply unit 350 is a secondary battery such as a lithium-ion battery, and receives power supplied from an external power source to store power, and supplies the power source to the controller 310 when the external power source is unavailable.

At least one of the display device 410, the audio output device 420, and the light emitting device 430 is connected to the I/F 340 by the USB or the like.

The display device 410 includes the display module 100 described in FIG. 1 and FIG. 2. The display device 410 controls the display region 118 to display images according to the control signals output from the sensor controller 230. The audio output device 420 is a speaker having a function of generating various sounds. The audio output is controlled by the control signal output from the sensor controller 230 in the audio output device 420. In addition, the light emitting device 430 is an illumination such as an LED. The light emission of the light emitting device 430 is controlled by the control signal output from the sensor controller 230.

### 6. Software for Controlling Sensor Module

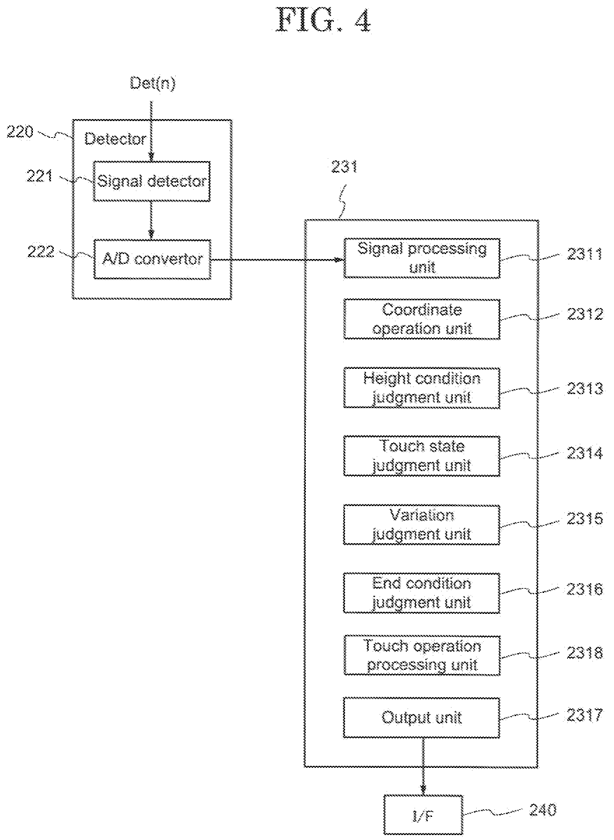

FIG. 4 is a block diagram illustrating software for controlling the sensor module 200 according to an embodiment of the present invention. A control method for the sensor module 200 is performed at the operation unit 231 of the sensor controller 230. The operation unit 231 includes a signal processing unit 2311, a coordinate operation unit 2312, a height condition determination unit 2313, a touch state determination unit 2314, a variation determination unit 2315, an end condition determination unit 2316, an output unit 2317, and a touch operation processing unit 2318.

The signal processing unit 2311 includes a signal processing circuit and corrects a baseline of the detection signal upon acquiring the detection signal from the A/D converter 222 of the detector 220. In addition, the signal processing unit 2311 transmits a signal S(n) after a linear transformation is executed for the baseline-corrected detection signal to the coordinate operation unit 2312.

The coordinate operation unit 2312 includes a coordinate operation circuit, generates the three-dimensional coordinate data indicating the position of the input means 290 in the sensor region 218 for each frame based on the signal S(n), and stores the generated coordinate data in the RAM 233. The coordinate data includes X coordinate data, Y coordinate data, and Z coordinate data. In the case where the sensor module is driven using one frame as 8 msec, the RAM 233 stores about 35 to 40 coordinate data. In addition, each time the latest coordinate data is stored, the oldest coordinate data is deleted.

The coordinate operation unit 2312 calculates the degree of variation of the X coordinate, the degree of variation of the Y coordinate, and the degree of variation of the Z coordinate for each frame using the coordinate data groups stored in the RAM 233. More specifically, each time a frame is updated, the new coordinate data is stored in the RAM 233, but the variation of each coordinate data is calculated using the latest coordinate data and a plurality of coordinate data retroactively from the latest coordinate data (in the present embodiment, for example, 36). In this case, the variance may be calculated, or the integration of the displacement of the coordinates may be calculated, as the degree of variation. For example, a predetermined period is preferably 300 msec or less. That is, in the case where the coordinate data is updated for each 8 msec, it is preferable to calculate the variation using 37 coordinate data (8×37=296 msec) including the latest coordinate data. If 300 msec is exceeded, a response for detecting a touch is delayed, or if a finger is used as the input means 290, the period of the touch is ended. In order to increase the resolution of the detection result, it is preferable to set the predetermined period to 240 msec or less. Similarly, it is preferable to set the predetermined period to 160 msec or less or 80 msec or less. In this way, the variation of the latest coordinate data is calculated, and the calculated variation is also stored in the RAM 233 as the variation data. The variation data for the latest coordinate data is acquired for each frame, but the RAM 233 stores the variation data for at least four frames for a plurality of frames. Needless to say, the latest variation data is stored every time the latest coordinate data is updated, and the oldest coordinate data is deleted.

The height condition determination unit 2313 includes a height condition determination circuit, and determines whether the Z coordinate of the latest coordinate data satisfies a first height condition and a second height condition. The first height condition is whether the Z-coordinate representing the height from the sensor region 218 is equal to or less than a first threshold. In the case where the height condition determination unit 2313 determines that the Z coordinate is equal to or less than the first threshold, this means that the input means 290 is proximate to the sensor region 218 to some extent (for example, within 100 mm from the sensor region as viewed in the height direction). In this case, the input means 290 may not touch the cover member 214. In the case where the height condition determination unit 2313 determines that the Z coordinate is not equal to or less than the first threshold (for example, exceeds the first threshold), this means that the input means 290 is not proximate to the sensor region 218.

In addition, the second height condition is whether the Z coordinate representing the height from the sensor region 218 is equal to or less than the second threshold when the first height condition is satisfied. In the case where the height condition determination unit 2313 determines that the Z coordinate is equal to or less than the second threshold, it determines that it is a touched state. In the present embodiment, in the case where the height condition determination unit 2313 determines that the Z coordinate is equal to or less than the second threshold, the input means 290 is reliably in contact with the cover member 214. The second threshold is less than the first threshold. In the case where the height condition determination unit 2313 determines that the Z coordinate is not equal to or less than the second threshold (greater than the second threshold), the input device 290 may not be in contact with the cover member 214.

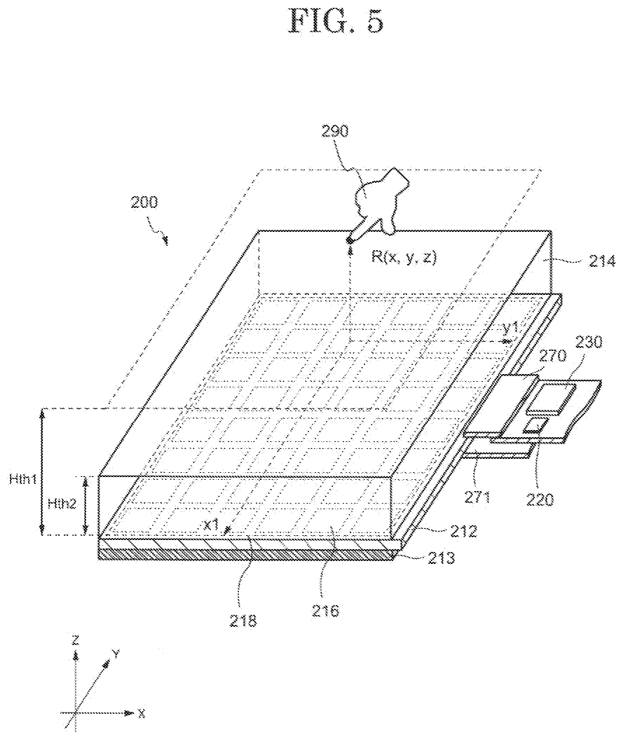

FIG. 5 is a diagram illustrating the first threshold and the second threshold at the Z coordinate in the sensor module. With reference to the sensor region 218 of the sensor module, a height to the surface of the cover member 214 is a second threshold Hth2, and a height away from the surface of the cover member 214 is a first threshold Hth1. FIG. 5 shows that the input means 290 is equal to or less than the first threshold Hth1 and exceeds the second threshold Hth2. FIG. 5 shows the three-dimensional coordinate data R (x, y, z) calculated by the coordinate operation unit.

The touch state determination unit 2314 includes a touch state determination circuit, and it is determined whether the input means 290 touched the cover member 214.

The variation determination unit 2315 includes a variation determination circuit, reads out the variation data stored in the RAM 233, and determines whether at least one of the variation in the Z coordinate (height variation), and the variation in the X coordinate and the variation in the Y coordinate (plane variation) is within a predetermined range with respect to the latest variation data. In other words, the variation determination unit 2315 may determine whether or not the latest variation data is within the predetermined range based on the variation of the Z coordinate. Alternatively, the variation determination unit 2315 may determine whether or not the latest variation data is within the predetermined range based on the variation of the XY coordinate. Alternatively, the variation determination unit 2315 may determine whether or not the latest variation data is within the predetermined range based on the variations of the Z coordinate and the XY coordinate. In addition, in the case where a determination unit 236 determines that at least one of the height variation and the plane variation is not within a predetermined range (the variation is large), it further determines whether the variation in a plurality of recently calculated frames including the frame (for example, 4 consecutive frames including the latest frame) is equal to or larger than a predetermined threshold. The determination may be made as to whether all of the variation data in these four frames is equal to or greater than the threshold, and in the variation data in these four frames, whether the variation data that is equal to or greater than the threshold exceeds half may be determined, and in the variation data in these four frames, whether the variation data is equal to or greater than the threshold in two consecutive or three consecutive frames may be determined.

The touch operation processing unit 2318 includes a touch operation processing circuit to transition to a touch state or to a non-touch state in response to a determination of the height condition determination unit 2313, the variation determination unit 2315, or the touch state determination unit 2314. The touch state is a state in which the input means 290 is in contact with the cover member 214, and the non-touch state is a state in which the input means 290 is away from the cover member 214, in the present embodiment.

The height position is detected based on the magnitude (detection strength) of the capacitance between the input means 290 and the sensor electrode 216 in the present embodiment. In this case, since the detection strength also depends on the size (finger size) and the like of the input means 290, it is difficult to obtain accurate height information of the input means 290 based only on the detection strength. In addition, a sensor electrode or the like is not arranged on the cover member 214 in the present embodiment. Therefore, in the case of determining that the input means 290 is in contact with the surface of the cover member 214 by using only the height information (Z coordinate data based on the detection strength) as the material for determining whether the input means 290 is in contact with the surface of the cover member 214 and by using only the height information corresponding to (or less than) the height position of the surface of the cover member 214, it is possible to assume a case where it is determined that the input means 290 is not in contact with the surface of the cover member 214, or vice versa.

On the other hand, in the case where the input means 290 is actually in contact with the cover member 214, at least one of the height and plane positions is stabilized over a long period (at least over several frames). That is, in the case where the input means 290 is in contact with the cover member 214, at least one (or both) of the height and plane variations is reduced over a long period. Therefore, the contact of the input means 290 on the cover member 214 is determined primarily based on the numerical value of the latest Z coordinate data, and a contact state of the final input means 290 is determined by referring to the height and plane variations by the variation determination unit 2315 depending on the numerical value of the Z coordinate, in the present embodiment. Determining the contact state of the input means 290 with the cover member 214 in a stepwise manner as described above, can help determination the contact state of the input means 290 more accurately.

The end condition determination unit 2316 includes an end determination circuit, and determines whether the end condition of the control method for a sensor module is satisfied. For example, the end condition is such that whether a predetermined time has elapsed since the start of the control method for a sensor module, and whether the end of the control method for a sensor module is selected.

The output unit 2317 has an output circuit and outputs a control signal corresponding to the position of the sensor region 218 to the I/F 240. The control signal is transmitted from the I/F 240 to the I/F of the computing device 300. Then, the application program is executed in the controller 310 based on the control signal, and the display device 410 and the like are controlled.

### 7. Control Method for Sensor Module

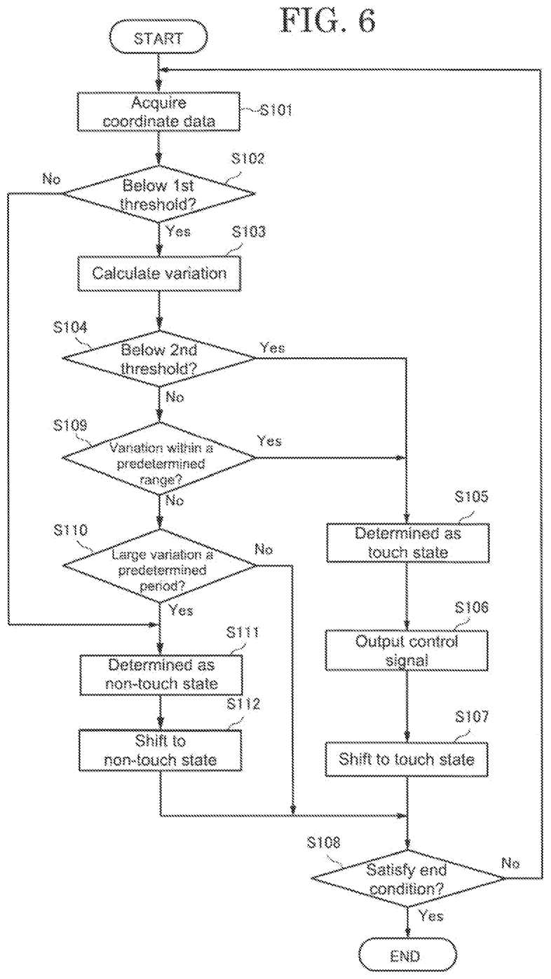

FIG. 6 is a flowchart showing a control method for the sensor module 200 according to an embodiment of the present invention. The control method for the sensor module 200 is initiated by the operation unit 231 of the sensor controller 230, and the signal processing unit 2311 obtains a digital detection signal from the detector 220 when the input means 290 approaches the sensor region 218. In addition, the initial state in which the touch is not recognized once after the control method for the sensor module 200 is started is the non-touch state.

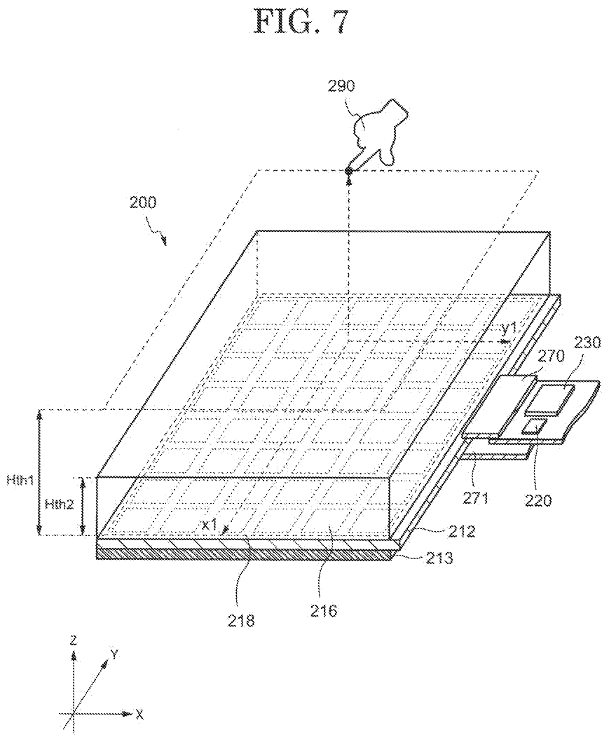

FIG. 7 is a perspective view of the sensor module 200 according to an embodiment of the present invention. FIG. 7 shows how the input means 290 approaches the sensor module 200. In this case, the signal processing unit 2311 corrects the baseline for the digital detection signal and transmits the signal S(n) subjected to the linear transformation to the coordinate operation unit 2312. When the coordinate operation unit 2312 generates the three-dimensional coordinate data R (x1, y1, z1) based on the signal S(n), the three-dimensional coordinate data is transmitted to the height condition determination unit 2313.

Next, upon acquiring the three-dimensional coordinate data R (step S101), the height condition determination unit 2313 determines whether the Z coordinate (in this case, z1) representing the height is equal to or less than the first threshold (step S102). In the case where the height condition determination unit 2313 determines that the Z coordinate is equal to or less than the first threshold (step S102; Yes), it is determined that the input means 290 is close to the sensor region 218. Next, the coordinate operation unit 2312 reads the three-dimensional coordinate data from the RAM 233 over several consecutive frames in step S103, and calculates variations in the X coordinate, variations in the Y coordinate, and variations in the Z coordinate. In addition, the operation result is stored in the RAM 233 as variation data.

Next, the height condition determination unit 2313 determines whether the Z coordinate (the latest Z coordinate) is equal to or less than the second threshold (step S104). If it is determined in the height condition determination unit 2313 that the Z coordinate is equal to or less than the second threshold (step S104; Yes), the touch state determination unit 2314 determines that the input means 290 is touching the cover member 214 (in the touch state) (step S105). In order to reliably determine that the input means 290 is in contact with the cover member 214 if it is equal to or less than the second threshold, the second threshold is set to a value equivalent to or slightly less than the height from the surface of the sensor region 218 to the surface of the cover member 214 (closer to the surface of the sensor electrode 216). Next, the control signal is output from the output unit 2317 in step S106. Thereafter, the touch operation processing unit 2318 transitions to the touch state in step S107.

The end condition determination unit 2316 determines whether the control method for the sensor module 200 satisfies the end condition. In the case where the end condition determination unit 2316 determines that the end condition of the control method for the sensor module 200 is satisfied (step S108; Yes), the control method for the sensor module 200 is terminated (END). In the case where the end condition determination unit 2316 determines that the end condition of the control method for the sensor module 200 is not satisfied (step S108; No), the process returns to step S101. In this case, the process returns to step S101 in the touch state.

Thereafter, the signal processing unit 2311 obtains a new digital detection signal from the detector 220 in step S101. In this case, the signal processing unit 2311 corrects the baseline for the digital detection signal and transmits the signal S(n) subjected to the linear transformation to the coordinate operation unit 2312. The coordinate operation unit 2312 generates three-dimensional coordinate data based on the signal S(n), and then the three-dimensional coordinate data is transmitted to the height condition determination unit 2313.

Next, upon receiving the three-dimensional coordinate data, the height condition determination unit 2313 determines whether the Z coordinate is equal to or less than the first threshold. In this case, if it is determined that the Z coordinate is not equal to or less than the first threshold (step S102; No), the touch state determination unit 2314 determines that the input means 290 is in the non-touch state in step S111. Then, the touch operation processing unit 2318 releases the touch state (shifts to the non-touch state) (step S112), and proceeds to step S108.

In the case where the height condition determination unit 2313 determines that the Z coordinate is larger than the second threshold (step S104; No) in step S104, the variation determination unit 2315 determines whether at least one of the latest height variation and the latest plane variation among the variation data stored in the RAM 233 is within a predetermined range (step S109). In addition, the latest height variation is a variation with respect to the latest Z coordinate among variations in a plurality of (37 in the present embodiment) Z coordinates retroactively including the latest Z coordinate. The same applies to the latest plane variation. When it is determined that the variation is within the predetermined range (step S109; Yes), the touch state determination unit 2314 determines that the input means 290 is touching the cover member 214 (step S105). After that, the process proceeds to step S106, and the control signal is output from the output unit 2317.

When it is determined that the variation of the coordinates is outside the predetermined range (step S109; No), the variation determination unit 2315 determines whether the variation of the coordinates in the predetermined period is large (step S110). More specifically, when the latest height variation (variation in the Z coordinate) described above is taken as DZₙ, it is determined whether the variation in DZₙ₋₁, DZₙ₋₂, . . . , DZₙ₋ₖ (k=3 in the present embodiment) is within a predetermined range. Similarly, when the above-described latest plane variation (variation in XY coordinates) is taken as DXYn, it is determined whether the variation in DXYₙ₋₁, DXYₙ₋₂, . . . , DXYₙ₋ₖ (k=3 in the present embodiment) is within a predetermined range. If it is determined that the degree of variation is large (step S110; Yes), the touch state determination unit 2314 determines that the input means 290 is in the non-touch state in step S111. After that, the process shifts to the non-touch state (releases the touch state) (step S112), and the process proceeds to step S108.

On the other hand, in the case where the variation determination unit 2315 determines that the variation is within a predetermined range (the degree of variation is small) (step S110; No), the touch-state proceeds to step S108 without being changed. In addition, various criteria can be set to determine whether the degree of variation in the variation determination unit 2315 is large or small. For example, a criterion of whether all of DZn to DZn-k are within a predetermined range may be used, a criterion of whether two or more consecutive ones of the variations are within a predetermined range in succession may be used, or a determination may be made as to whether the number within the predetermined range is equal to or more than half of the total number. The same applies to the plane variation. In addition, the predetermined range may be a range that is different from the predetermined range set at the time of determination in the step S109, for example, a range slightly larger than the range.

As described above, according to the control method for the touch sensor system 10 according to the embodiment of the present invention, it is determined whether a touch has been made based on the variation in the coordinates representing the fluctuation in the position of the input means 290 using the three-dimensional coordinate data based on a detection signal corresponding to the position of the input unit. As a result, since it is possible to determine whether a touch has been made regardless of the size of the input means 290, for example, the strength of the detection signal depending on the size of the finger, it is possible to improve the touch sensitivity. As described above, even in the case where the sensor substrate and the contact surface of the inputting unit are separated from each other in the touch sensor system 10 using the hover sensor, the sensitivity of the touch state can be improved.

### Second Embodiment

The case where the control method for the sensor module 200 is executed in the controller 310 of the computing device 300 will be described in the present embodiment.

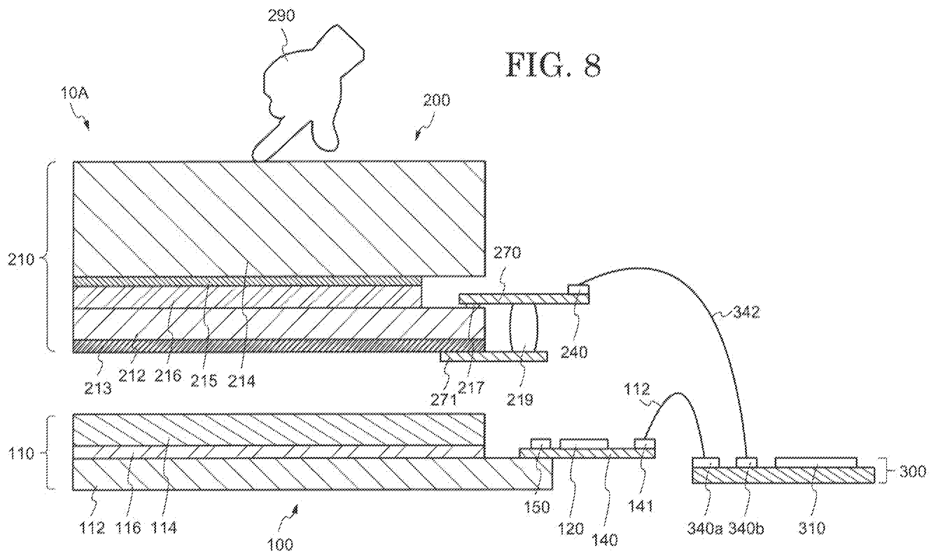

FIG. 8 is a schematic cross-sectional view of a touch sensor system 10 according to an embodiment of the present invention. The sensor module 200 is different from the first embodiment in that the detector, the sensor controller, and the printed circuit substrate are omitted, as shown in FIG. 8. The connector 270 is connected to the terminal 217 arranged on the first surface of the sensor substrate 212. The I/F 340b of the computing device 300 is connected to the I/F 240 of the sensor module 200 by the connection means 342.

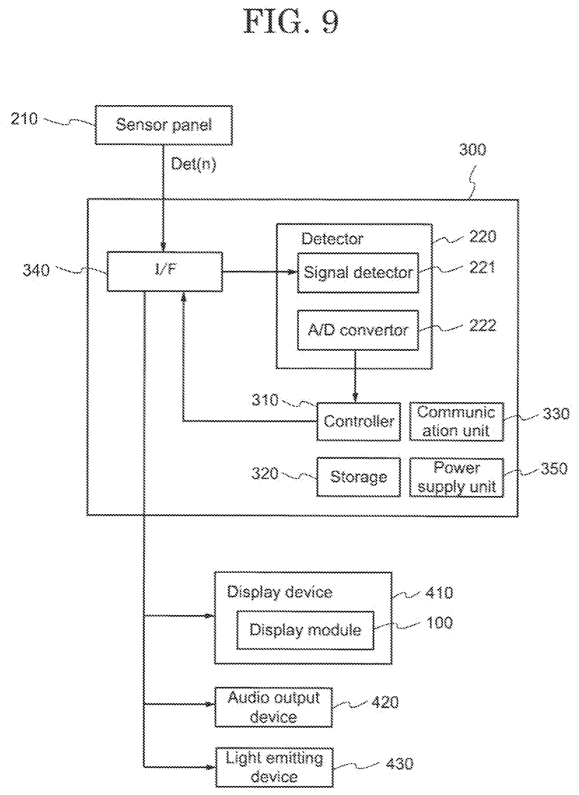

FIG. 9 is a diagram illustrating hardware of a touch sensor system 10A according to an embodiment of the present invention. The detector 220 is included in the computing device 300 and coordinate data is transmitted from the detector 220 to the controller 310, as shown in FIG. 9.

A signal Det (n) acquired from the sensor panel 210 is transmitted to the detector 220 via the I/F 340. A change in capacitance of the sensor electrode 216 is detected as a voltage change by the signal detector 221, and the voltage change is digitized and converted into the detection signal by the A/D converter 222 in the detector 220. The detection signal is transmitted to the controller 310.

The storage 320 stores a program for causing the controller 310 to execute the control method for the sensor module 200 described in the first embodiment. The storage 320 stores various application programs.

The controller 310 reads a program for implementing the control method for the sensor module 200 described in the first embodiment from the storage 320, and executes the program. That is, the control method for the sensor module 200 described with reference to FIG. 6 is executed in the controller 310. In addition, the controller 310 reads an application program for controlling the external output device and executes the program. The application program may be executed based on the control signal output from the controller 310 to control the display of the display device 410, output the sound from the audio output device 420, or turn on the light emitting device 430.

### Modifications

While an embodiment of the present invention has been described above, an embodiment of the present invention may be modified into various forms as follows. In addition, the above-described embodiments and the modifications described below can be applied in combination with each other as long as there is no inconsistency. Further, it is possible to add, delete, or replace another configuration with respect to part of the configuration of each embodiment.

(1) Although the case where a material having a thickness of 1 mm or more and 100 mm or less is used as the cover member 214 has been described in the embodiment described above, the thickness of the cover member 214 is not limited to this.

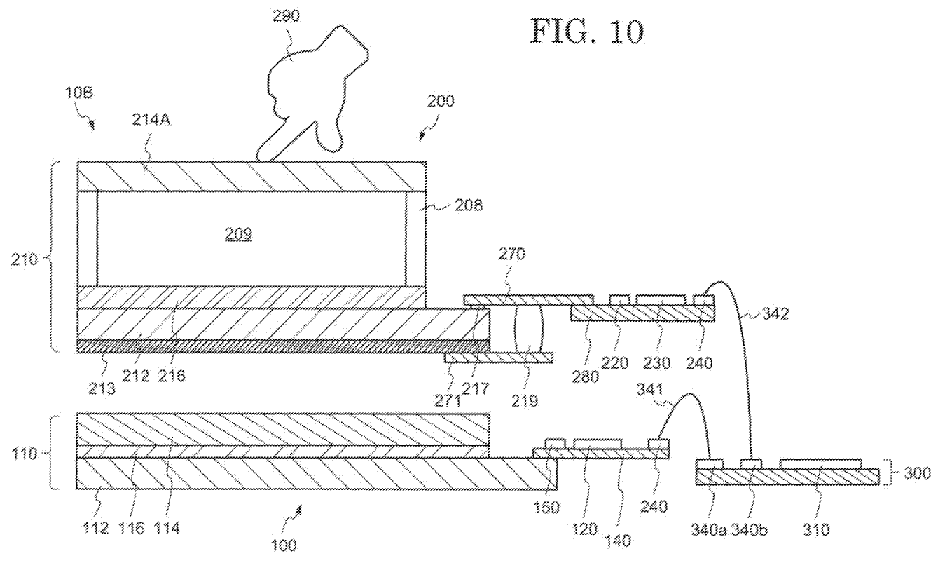

FIG. 10 is a cross-sectional view of a touch sensor system 10B according to an embodiment of the present invention. An air gap 209 may be arranged between the sensor substrate 212 and a cover member 214A, as shown in FIG. 10. A spacer 208, which also functions as an adhesive, is arranged between the sensor substrate 212 and the cover member 214A. The spacer 208 is arranged so as to surround the sensor region 218. The sum of the thickness of the cover member 214 and the thickness of the air gap 209 may be 1 mm or more and 100 mm or less. Therefore, the thickness of the cover member 214 may be less than 5 mm depending on the thickness of the air gap 209.

(2) Although the case where the first threshold of the height condition determination unit 2313 is the same as the thickness of the cover member 214 in the control method for the touch sensor system 10 has been described in the embodiments described above, the embodiment is not limited to this. The first thresholds may be greater than the thickness of the cover member 214. That is, the touch state may be detected in a state without contact with the cover member 214. In this case, the thickness of the cover member 214 is preferably less than 100 mm.

(3) Although the case where the degree of variation and the variation in a predetermined time are calculated using the three-dimensional coordinate data in the coordinate operation unit 2312 has been described in the above-described embodiment, the embodiment is not limited to this. For example, a degree of variation in a position of a finger, that is, a Signal value (or a detection signal (Raw data)) in the sensor region is highest, and the Signal value around the position may be calculated, in the signal processing unit 2311.

(4) Each of the display module 100, the sensor module 200, and the computing device 300 may be arranged in a separate housing in the touch sensor systems 10 and 10B. In this case, the display device including the display module 100 and the sensor device including the sensor module 200 may be connected to the computing device 300 by USB. Alternatively, the sensor module 200 may be incorporated in the display device together with the display module 100 in the touch sensor systems 10 and 10B. In this case, the display device may be connected to the computing device 300 by USB. Alternatively, each of the display module 100, the sensor module 200, and the computing device 300 may be arranged in one housing in the touch sensor systems 10 and 10B. In addition, the housing for storing the sensor module 200 may be a so-called casing or a table. Since the sensor module 200 can detect a touch even when the sensor region 218 and the input means 290 are separated from each other, the cover member 214 can also be used as a top plate of a table. The sensor module 200 may be embedded in a wall.

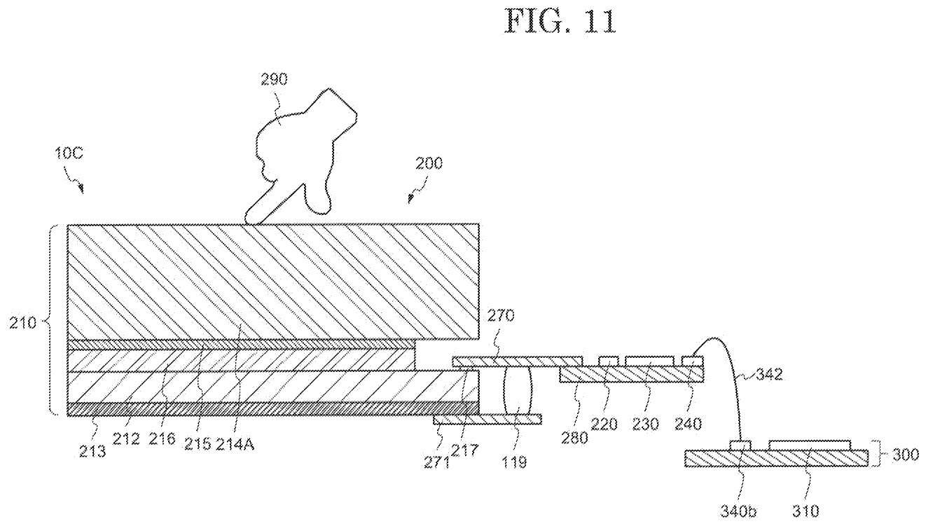

FIG. 11 is a cross-sectional view of a touch sensor system 10C according to an embodiment of the present invention. Although the configuration in which the sensor module 200 is arranged on the display module 100 has been described in FIG. 1, the present invention is not limited to this. The touch sensor system 10 may have a configuration in which the display module 100 is omitted as compared with the touch sensor system 10 illustrated in FIG. 1. That is, the touch sensor system 10 may be configured by the sensor module 200 and the computing device 300. Since images need not be displayed via the sensor module 200 in the touch sensor system 10C shown in FIG. 11, the cover member 214A may not have light transmittance. Any insulating material may be used, for example, wood or the like may be used as the cover member 214A. In addition, although FIG. 2 illustrates that the sensor electrode 216 is formed in a mesh-like manner having a plurality of openings, the present invention is not limited to this. Since images need not be displayed via the sensor module 200 in FIG. 11, the configuration of the sensor electrode 216 may be an island-like conductive layer that is not mesh-like. Incorporating the sensor module 200 into the table in the touch sensor system 10C makes it possible to use the cover member 214 as a top plate of the table and to embed the sensor module 200 in the wall. As a result, the sensor module 200 can be hidden behind the top plate of the table or behind the wall. In addition, the table and the wall are examples, and there is no limitation on furniture to which the touch sensor system 10C can be applied. In this case, a mark (for example, a button mark for prompting the user to turn on/off the illumination) for prompting the user to touch may be arranged in the part corresponding to the sensor region 218 of the sensor module 200 of the table or the wall.

Each of the embodiments and modifications described above as an embodiment of the present invention can be appropriately combined and implemented as long as no contradiction is caused. Further, the addition, deletion, or design change of components, or the addition, deletion, or condition change of process as appropriate by those skilled in the art based on the sensor system of each embodiment are also included in the scope of the present invention as long as they are provided with the gist of the present invention.

Further, it is understood that, even if the advantageous effect is different from those provided by each of the above-described embodiments, the advantageous effect obvious from the description in the specification or easily predicted by persons ordinarily skilled in the art is apparently derived from the present invention.

What is claimed is:

1. A sensor module comprising:
a cover member;
a contactless sensor substrate arranged with a sensor region having a plurality of sensor electrodes and overlapping the cover member; and
a controller receiving a detection signal output from the sensor substrate and generating three-dimensional coordinate data based on the detection signal,
wherein
the controller includes a coordinate calculation unit generating the three-dimensional coordinate data indicating a position of an input means in the sensor region when the input means is in proximity to the sensor region,
a height condition determination unit determining whether or not a Z-coordinate representing a height from the sensor region in the three-dimensional coordinate data is less than a first threshold value and whether or not the Z-coordinate is a second threshold value is less than the first threshold value, and
an output unit outputting a control signal corresponding to the position of the sensor region when the height condition determination unit determines that the Z-coordinate is equal to or less than the first threshold value and the second threshold value.

2. The sensor module according to claim 1, wherein the controller includes a touch operation processing unit to shift to a touch state after outputting the control signal.

3. The sensor module according to claim 2, wherein the touch operation processing unit shifts from the touch state to a non-touch state when the height condition determination unit determines that the Z-coordinate exceeds the first threshold value in a state of transition to the touch state.

4. The sensor module according to claim 2, wherein the controller further includes a variation determination unit determining when the height condition determination unit determines that the Z coordinate exceeds the second threshold, whether at least one of the variation of the Z coordinate and the variation of the XY coordinate representing the horizontal plane is within a predetermined range in the most recent multiple frames of the coordinate data in the three dimensions.

5. The sensor module according to claim 4, wherein the touch operation processing unit shift to the non-touch state from the touch state, when the variation determination unit determines at least one of the variation of the Z coordinate and the variation of the XY coordinate representing the horizontal plane relative to the sensor area is outside the predetermined range, and when at least one of the variation of the Z coordinate and the variation of the XY coordinate is outside the predetermined range in the most recent multiple frames.

6. The sensor module according to claim 1, wherein a thickness of the cover member is 1 mm or more and 100 mm or less.

7. The sensor module according to claim 1 further comprising:
a spacer arranged on the sensor substrate to surround the sensor region, wherein the cover member is arranged over the sensor region via the spacer.

8. A method for controlling a sensor module, the sensor module comprising a cover member and a sensor region having a plurality of sensor electrodes and detecting a detection signal output from a contactless sensor substrate overlapping the cover member,
the method comprising steps of:
generating a three-dimensional coordinate data indicating a position of an input means in the sensor region based on a detection signal output from the sensor substrate when the input means is in proximity to the sensor region; and
outputting a control signal corresponding to a position in the sensor region when the height condition determination unit determines that the Z-coordinate is equal to or less than the first threshold value and the second threshold value.

9. The method according to claim 8, further comprising:
sifting to the touch state after outputting the control signal.

10. The method according to claim 9, further comprising:
shifting to the non-touch state from the touch state, when the Z-coordinate exceeds the first threshold value in a state of transition to the touch state.

11. The method according to claim 9, further comprising:
outputting the control signal when the Z coordinate exceeds the second threshold, and at least one of the variation of the Z coordinate and the variation of the XY coordinate representing the horizontal plane in the most recent multiple frames of the 3D coordinate data is within a predetermined range.

12. The method according to claim 11, further comprising:
shifting to the touch state from the non-touch state when at least one of the variation of the Z coordinate and the variation of the XY coordinate representing the horizontal plane relative to the sensor area is outside the predetermined range, and at least one of the variation of the Z coordinate and the variation of the XY coordinate is outside the predetermined range in the most recent plurality of frames, the touch state is shifted to the non-touch state.
